(19) United States
(12) Patent Application Publication
(10) Pub. No.: US 2026/0194636 A1
(43) Pub. Date: Jul. 9, 2026

(54) DISTANCE MEASURING DEVICE AND DISTANCE MEASURING METHOD

(71) Applicant: Nuvoton Technology Corporation Japan, Kyoto (JP)

(72) Inventors: Mayu OGAWA, Kyoto (JP); Yoshinao KAWAI, Kyoto (JP)

(21) Appl. No.: 19/554,241

(22) Filed: Mar. 2, 2026

Related U.S. Application Data
(63) Continuation of application No. PCT/JP2024/033811, filed on Sep. 24, 2024.

(30) Foreign Application Priority Data
Sep. 25, 2023 (JP) 2023-159368

(51) Int. Cl. G01S 7/484; G01S 17/10; G01S 17/89

(52) U.S. Cl. CPC G01S 7/484; G01S 17/10; G01S 17/89

(57) ABSTRACT

A distance measuring device includes: a light source that irradiates a predetermined range with irradiation light; a light receiver including a plurality of pixels; an image recognizer that obtains an image showing at least a part of the predetermined range, and detects a recognition target object, by performing image recognition on the obtained image; a drive controller that adjusts an irradiation condition of the irradiation light, based on a first output that each of one or more pixels outputs based on the reflected light of the irradiation light emitted under a predetermined irradiation condition, the one or more pixels corresponding to a region including the recognition target object; and a distance calculator that calculates the distance to the recognition target object, based on a second output that each of the plurality of pixels outputs based on the reflected light of the irradiation light emitted under the adjusted irradiation condition.

### CROSS REFERENCE TO RELATED APPLICATIONS

This is a continuation application of PCT International Patent Application No. PCT/JP2024/033811 filed on Sep. 24, 2024, designating the United States of America, which is based on and claims priority of Japanese Patent Application No. 2023-159368 filed on Sep. 25, 2023. The entire disclosures of the above-identified applications, including the specifications, drawings and claims are incorporated herein by reference in their entirety.

### FIELD

The present disclosure relates to a distance measuring device and a distance measuring method.

### BACKGROUND

Conventionally, distance measuring devices employing indirect time of flight (TOF) methods are known. A distance measuring device employing an indirect TOF method includes, for example, a light source and a light receiver. In such a distance measuring device, a light receiver receives reflected light from a target object irradiated with the irradiation light from a light source, and the distance measuring device generates a distance image using a signal based on the reflected light output by the light receiver.

In the distance measuring device employing the indirect TOF method, when the amount of light irradiated onto the target object is small, a signal level output by the light receiver decreases, leading to a lower the signal-to-noise (SN) ratio. Thus, the accuracy of distance measurement decreases. Moreover, when the amount of light irradiated onto the target object is too high, a signal level output by the light receiver becomes saturated. Thus, it is no longer possible to accurately measure the distance. As such, to improve the accuracy of distance measurement, techniques related to adjusting the amount of irradiation light from a light source of a distance measuring device have been proposed (for example, refer to Patent Literature (PTL) 1).

### CITATION LIST

### Patent Literature

PTL 1: Japanese Unexamined Patent Application Publication No. 2008-241435

### SUMMARY

### Technical Problem

Conventional techniques require further improvement in the distance measurement accuracy.

The present disclosure provides a distance measuring device and a distance measurement method that are capable of improving the accuracy of distance measurement.

### Solution to Problem

A distance measuring device according to one aspect of the present disclosure includes: a light source that irradiates a predetermined range with irradiation light; a light receiver including a plurality of pixels that receive reflected light resulting from reflection of the irradiation light within the predetermined range; an image recognizer that obtains an image showing at least a part of the predetermined range, and detects a recognition target object that is predetermined, by performing image recognition on the image obtained; a drive controller that, when the image recognizer has detected the recognition target object, (i) adjusts an irradiation condition of the irradiation light emitted by the light source, based on a first output that each of one or more pixels outputs based on the reflected light of the irradiation light emitted under a predetermined irradiation condition, the one or more pixels being pixels corresponding to a region including the recognition target object among the plurality of pixels, and (ii) causes the light source to emit the irradiation light under the irradiation condition adjusted; and a distance calculator that calculates a distance to the recognition target object, based on a second output that each of the plurality of pixels outputs based on the reflected light of the irradiation light emitted under the irradiation condition adjusted.

A distance measuring method according to another aspect of the present disclosure is a distance measuring method performed by a distance measuring device, the distance measuring device including: a light source that irradiates a predetermined range with irradiation light; and a light receiver including a plurality of pixels that receive reflected light resulting from reflection of the irradiation light within the predetermined range. The distance measuring method includes: obtaining an image showing at least a part of the predetermined range, and detecting a recognition target object that is predetermined, by performing image recognition on the image obtained; when the recognition target object is detected in the obtaining and detecting of the image and the recognition target object, (i) adjusting an irradiation condition of the irradiation light emitted by the light source, based on a first output that each of one or more pixels outputs based on the reflected light of the irradiation light emitted under a predetermined irradiation condition, the one or more pixels being pixels corresponding to a region including the recognition target object among the plurality of pixels, and (ii) causing the light source to emit the irradiation light under the irradiation condition adjusted; and calculating a distance to the recognition target object based on a second output that each of the plurality of pixels outputs based on the reflected light of the irradiation light emitted under the irradiation condition adjusted.

### Advantageous Effects

The present disclosure can improve the accuracy of distance measurement.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a functional block diagram illustrating an example of a configuration of a distance measuring device according to an embodiment.

FIG. 2 is a schematic illustration of a light receiver included in the distance measuring device according to the embodiment.

FIG. 3A is a schematic illustration for explaining a pixel arrangement example in an image sensor included in the light receiver according to the embodiment.

FIG. 3B is a schematic illustration for explaining a pixel arrangement example in an image sensor included in the light receiver according to the embodiment.

FIG. 3C is a schematic illustration for explaining a pixel arrangement example in an image sensor included in the light receiver according to the embodiment.

FIG. 3D is a schematic illustration for explaining a pixel arrangement example in an image sensor included in the light receiver according to the embodiment.

FIG. 3E is a schematic illustration for explaining a pixel arrangement example in an image sensor included in the light receiver according to the embodiment.

FIG. 3F is a schematic illustration for explaining a pixel arrangement example in an image sensor included in the light receiver according to the embodiment.

FIG. 4 illustrates an example of a driving sequence of the distance measuring device according to the embodiment.

FIG. 5A illustrates an example of timings of an emission control pulse and exposure control pulses during an A0/A1 period.

FIG. 5B illustrates an example of timings of an emission control pulse and exposure control pulses during an A2/A3 period.

FIG. 6A illustrates examples of signals based on charges generated by exposures during the A0/A1 period.

FIG. 6B illustrates examples of signals based on charges generated by exposures during the A2/A3 period.

FIG. 7 is a flowchart illustrating an operation example of the distance measuring device according to the embodiment.

FIG. 8 illustrates a specific example of detection of a recognition target object by an image recognizer according to the embodiment.

FIG. 9 is a figure for explaining a condition table for adjusting an irradiation condition of irradiation light.

FIG. 10 is a figure for explaining a method for correcting a second irradiation condition based on the temperature of the light receiver.

### DESCRIPTION OF EMBODIMENT

### (Circumstances Leading to One Aspect of the Present Disclosure)

As described above, in a distance measuring device employing an indirect TOF method, if the amount of light irradiated onto a target object is not appropriate, the accuracy of distance measurement decreases. For instance, the amount of irradiation light reaching the target object attenuates in proportion to the square of the distance between a light source and the target object. Thus, the appropriate amount of irradiation light varies depending on the distance between the light source and the target object.

PTL 1 discloses a technique for adjusting the amount of irradiation light from the light source of a distance measuring device to improve the accuracy of distance measurement. Specifically, in the technique disclosed in PTL 1, a light receiver receives reflected light from a target object, converts the reflected light into charge, and adjusts the amount of light of the light source based on the charge accumulated in a charge accumulator. However, in the technique disclosed in PTL 1, since it is not known that the reflected light from the target object is reflected light from a target object for distance measurement, it may not be possible to appropriately adjust the amount of light of the light source. For instance, if two or more target objects are present in the irradiation range of the light source, the amount of irradiation light may be adjusted using reflected light from an object other than the target object for distance measurement. Moreover, for instance, the amount of reflected light from a target object received by the light receiver varies depending on the reflectance of the target object. Thus, if the amount of irradiation light is adjusted using reflected light from a target object with reflectance different from that of the target object for distance measurement, the amount of light may not be appropriately adjusted for the target object for distance measurement.

The present disclosure has been made in view of the above observations of the inventors of the present application, and provides a distance measuring device and a distance measuring method that are capable of improving the accuracy of distance measurement by more appropriately adjusting an irradiation condition of irradiation light emitted by the light source.

Hereinafter, an embodiment in the present disclosure is described in detail with reference to the drawings.

It should be noted that the embodiment described below indicates a comprehensive or specific example. The numerical values, shapes, elements, arrangement and connection of the elements, steps, order of steps, and so forth indicated in the embodiment described below are merely examples, and do not intend to limit the present disclosure. Moreover, among the elements described in the embodiment below, those not recited in the independent claims are described as optional elements. Moreover, the figures are schematic illustrations and are not necessarily precise depictions. Moreover, in the figures, substantially the same elements are assigned the same reference signs, and overlapping explanations may be omitted or simplified.

### EMBODIMENT

### [Configuration]

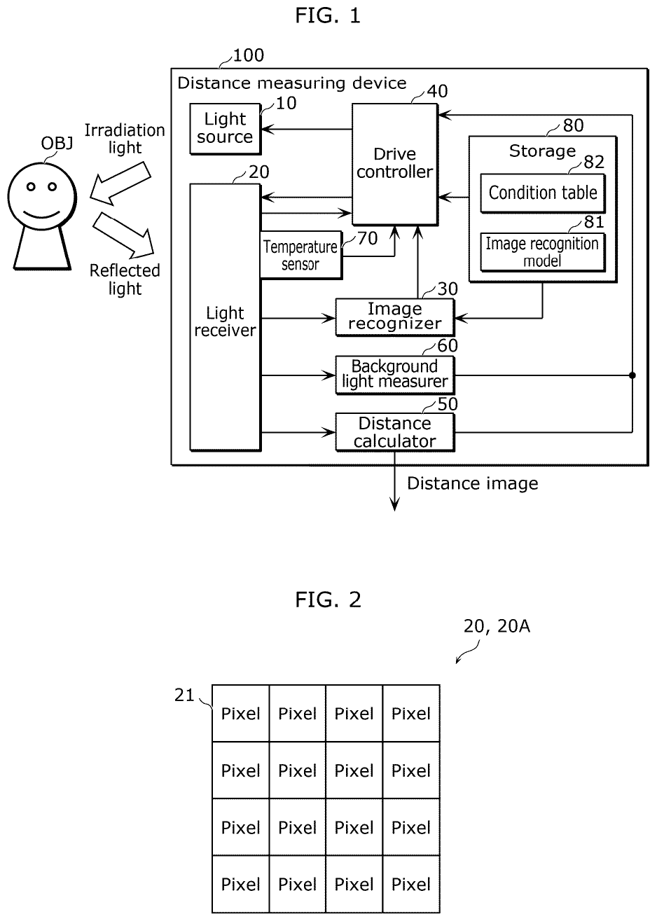

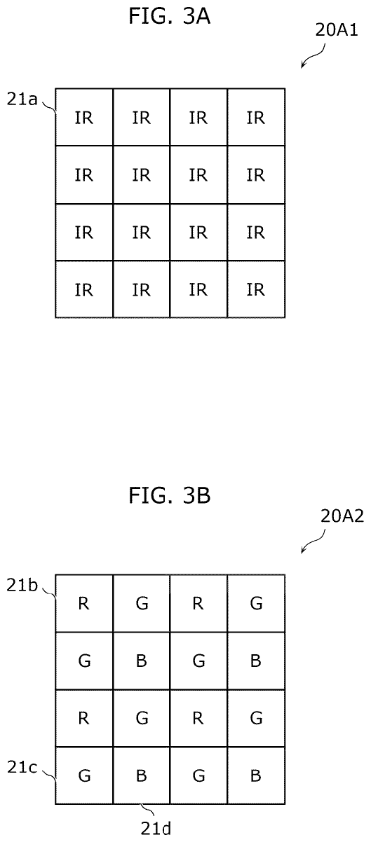

First, a configuration of a distance measuring device according to an embodiment is described. FIG. 1 is a functional block diagram illustrating an example of a configuration of distance measuring device 100 according to the embodiment. FIG. 2 is a schematic illustration of light receiver 20 included in distance measuring device 100 according to the embodiment.

Distance measuring device 100 is a distance measuring device that measures the distance by an indirect TOF method. Distance measuring device 100 generates a distance image indicating the distance to a target object within an imaging range. Since distance measuring device 100 according to the embodiment can improve the accuracy of distance measurement, for instance, it is possible to reduce the number of authentication retries in image authentication systems, such a facial authentication system and a driver monitoring system. This can lead to higher performance of authentication processing. As such, distance measuring device 100 may be used in image authentication systems, such a facial authentication system and a driver monitoring system.

As illustrated in FIG. 1, distance measuring device 100 includes light source 10, light receiver 20, image recognizer 30, drive controller 40, distance calculator 50, background light measurer 60, temperature sensor 70, and storage 80.

In accordance with the input emission control signal, light source 10 irradiates, with irradiation light, a predetermined range (a target space for distance measurement) including at least a part of an imaging range of light receiver 20. An irradiation condition of the irradiation light from light source 10 is controlled by the input emission control signal. For instance, in accordance with the timing indicated by an emission control pulse included in the input emission control signal, light source 10 irradiates the predetermined range with pulsed light with a predetermined pulse width more than one time. FIG. 1 schematically illustrates a case where predetermined recognition target object OBJ is present within the predetermined range. Light source 10 includes, for example, a light-emitting diode that emits infrared (IR) light or a light-emitting element, such as a laser element, as well as an optical system onto which the light from the light-emitting element is incident and which controls distribution of the light from the light-emitting element.

Light source 10 may be able to change the emission intensity of light source 10 as an irradiation condition of irradiation light. A known light control method can be used to change the emission intensity of light source 10. For instance, light source 10 includes light-emitting elements, and changes the emission intensity by changing the number of light-emitting elements to be lit. Light source 10 may change the emission intensity by changing the voltage applied to the light-emitting elements.

Moreover, light source 10 may be able to change the distribution angle of irradiation light as an irradiation condition of irradiation light. For instance, light source 10 includes sub-light sources with mutually different distribution angles of irradiation light, and changes the distribution angle of irradiation light by switching between the sub-light sources for light emission. Moreover, light source 10 may change the distribution angle of irradiation light by switching between optical systems onto which the light from a light-emitting element is incident. Moreover, light source 10 may continuously change the distribution angle by, for example, combining optical systems onto which the light from a light-emitting element is incident, and adjusting the distance between the optical systems. When light source 10 emits light at the same emission intensity, the narrower the distribution angle of irradiation light is, the higher the irradiation intensity of irradiation light is, which leads to higher illuminance of the light irradiated onto recognition target object OBJ. That is, by changing the distribution angle, it is possible to increase the amount of irradiation light reaching recognition target object OBJ, without increasing the emission intensity or the emission amount of light emitted by the light-emitting elements of light source 10.

In light source 10, irradiation conditions of irradiation light that are to be controlled by an input emission control signal include, for example, at least one of the emission count of pulsed light, the emission intensity of light source 10, or the distribution angle of irradiation light.

As illustrated in FIG. 2, light receiver 20 includes one or more image sensors 20A. Image sensor 20A receives light from a predetermined range, and captures an image showing at least a part of the predetermined range. Image sensor 20A is, for example, a charge-coupled device (CCD) sensor or a complementary metal-oxide-semiconductor (CMOS) sensor. Image sensor 20A includes two-dimensionally arrayed pixels 21. For the sake of explanation, FIG. 2 illustrates a configuration of 16 pixels in total, consisting of 4 horizontal and 4 vertical pixels. However, the number of pixels 21 included in image sensor 20A is not particularly limited. For instance, the number of pixels 21 included in image sensor 20A may range from 20,000 pixels to 5 million pixels, inclusive.

Each of pixels 21 includes at least one photoelectric conversion element that receives reflected light resulting from reflection of the irradiation light from light source 10 by recognition target object OBJ or the like in a predetermined range, and converts the received light into charge. For instance, a photodiode is used as a photoelectric conversion element.

Each of pixels 21 outputs a signal based on charge obtained by exposure performed in accordance with an exposure control signal. For instance, for each pixel 21, image sensor 20A transfers the charge obtained by the exposure performed in accordance with the exposure control signal to a vertical charge-coupled device (VCCD) or a charge accumulator (FD), and reads out the signal based on the charge obtained by the exposure. For instance, in the signal readout, image sensor 20A performs analog-to-digital (AD) conversion, and outputs a digital signal obtained by the AD conversion. An exposure period in image sensor 20A is, for example, associated with an emission period of the irradiation light from light source 10. Moreover, when light source 10 emits pulsed light more than one time, the number of exposure periods is set according to the emission count of pulsed light.

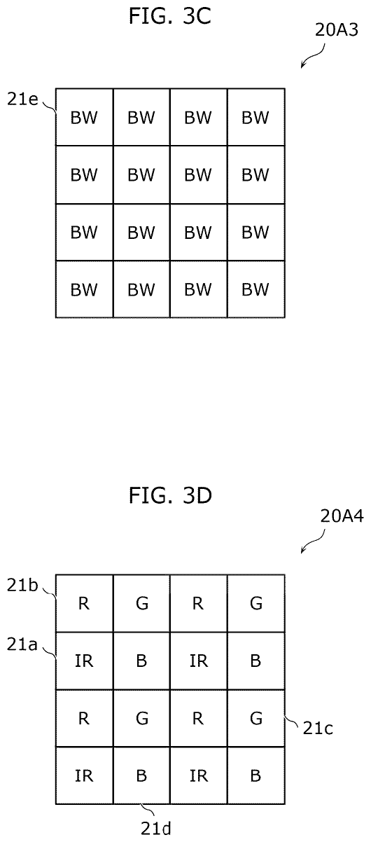

Here, an example of arrangement of pixels 21 in image sensor 20A is described. FIGS. 3A to 3F are schematic illustrations for explaining examples of pixel arrangement in an image sensor included in light receiver 20 according to the embodiment.

For instance, light receiver 20 includes image sensors 20A. In this case, for instance, light receiver 20 includes, as image sensors 20A, (i) image sensor 20A1 illustrated in FIG. 3A and (ii) at least one of image sensor 20A2 illustrated in FIG. 3B or image sensor 20A3 illustrated in FIG. 3C.

As illustrated in FIG. 3A, in image sensor 20A1, each of pixels 21 is IR-sensitive IR pixel 21a. In image sensor 20A1, IR pixels 21a are arranged in a matrix. IR pixels 21a receive the reflected light of the irradiation light from light source 10, and each outputs a signal based on the received reflected light. The signal output by IR pixel 21a is used to generate an IR image and a distance image.

As illustrated in FIG. 3B, image sensor 20A2 include, as pixels 21, R pixels 21b sensitive to red light, G pixels 21c sensitive to green light, and B pixels 21d sensitive to blue light. In image sensor 20A2, R pixels 21b, G pixels 21c, and B pixels 21d are arranged in a Bayer array. Signals output by R pixel 21b, G pixel 21c, and B pixel 21d are used to generate a color visible light image (RGB image).

As illustrated in FIG. 3C, in image sensor 20A3, each of pixels 21 is BW pixel 21e sensitive to the full range of visible light. In image sensor 20A3, BW pixels 21e are arranged in a matrix. A signal output by BW pixel 21e is used to generate a monochrome visible light image (BW image).

Moreover, light receiver 20 may include just one image sensor 20A. In this case, as image sensor 20A, light receiver 20 includes image sensor 20A4 illustrated in FIG. 3D, image sensor 20A5 illustrated in FIG. 3E, or image sensor 20A6 illustrated in FIG. 3F.

As illustrated in FIG. 3D, image sensor 20A4 includes, as pixels 21, IR pixels 21a, R pixels 21b, G pixels 21c, and B pixels 21d. Image sensor 20A4 has a pixel array where half of G pixels 21c of image sensor 20A2 are replaced by IR pixels 21a.

As illustrated in FIGS. 3E and 3F, each of image sensor 20A5 and image sensor 20A6 includes IR pixel 21a and BW pixel 21e as pixels 21. Image sensor 20A5 has a pixel array where adjacent pixels are IR pixel 21a and BW pixel 21e in each of a row direction and a column direction. In the pixel array of image sensor 20A6, adjacent pixels in the column direction are IR pixel 21a and BW pixel 21e, and in the row direction, either IR pixels 21a or BW pixels 21e are arranged.

Because of the above configuration of light receiver 20, it is possible to generate an IR image, a distance image, and a visible light image using a signal output by light receiver 20. It should be noted that it is not necessary to generate a visible light image using a signal output by light receiver 20, and if a visible light image is not generated, light receiver 20 may include just one image sensor 20A1.

The explanation returns to FIG. 1. Image recognizer 30 obtains an image showing at least a part of the predetermined range irradiated with the irradiation light from light source 10, and performs image recognition on the obtained image. Image recognizer 30 detects predetermined recognition target object OBJ by performing the image recognition on the image showing at least a part of the predetermined range. A known method can be used in the image recognition by image recognizer 30. For instance, image recognizer 30 outputs the position of a region showing recognition target object OBJ, using trained image recognition model 81, which was pre-trained by machine learning to detect recognition target object OBJ from an image. For instance, image recognizer 30 extracts features from an image, and inputs the extracted features into image recognition model 81. For instance, image recognition model 81 is stored in storage 80 as image recognition model 81 pre-trained by machine training using training images, and outputs the probability that predetermined recognition target object OBJ is present in the image, in response to an input of features. When the probability output by image recognition model 81 is greater than or equal to a predetermined threshold, image recognizer 30 determines that recognition target object OBJ is present. As a non-limiting example, a neural network model is used as image recognition model 81.

The type of recognition target object OBJ is set, for example, according to the application in which distance measuring device 100 is used, and is not particularly limited. Examples of recognition target objects OBJ include a human face, a human hand, an entire person, a mobile object, such as a vehicle, a building, and an animal. It should be noted that an image recognition method performed by image recognizer 30 is not particularly limited. For instance, when recognition target object OBJ is a human face, the human face may be detected using a known face detection algorithm. Moreover, two or more types of recognition target objects OBJ may be detected through the image recognition by image recognizer 30. For instance, image recognizer 30 may detect a person and a vehicle as recognition target objects OBJ.

Drive controller 40 outputs various control signals for controlling the driving of light source 10 and light receiver 20. As a control signal for controlling the driving of light source 10, for instance, drive controller 40 outputs an emission control signal instructing light source 10 to emit irradiation light with a predetermined pulse width. Moreover, as a control signal for controlling the driving of light receiver 20, drive controller 40 outputs an exposure control signal instructing exposure of each pixel 21 of light receiver 20. Drive controller 40 adjusts an irradiation condition of the irradiation light from light source 10, based on the output of light receiver 20 and the result of detection of recognition target object OBJ by image recognizer 30.

Distance calculator 50 performs predetermined calculation, based on the signal output for each pixel 21 (specifically, IR pixel 21a) that has received the reflected light of the irradiation light within the predetermined range, to generate a distance image. For instance, distance calculator 50 calculates the distance to recognition target object OBJ for each pixel 21, based on the signal output for each pixel 21. Distance calculator 50 outputs the distance calculated for each pixel 21 as a pixel value.

Background light measurer 60 obtains the signal output by pixel 21 of light receiver 20 based on background light not including the reflected light of the irradiation light from light source 10. It should be noted that distance measuring device 100 need not include background light measurer 60.

It should be noted that drive controller 40, distance calculator 50, and background light measurer 60 are, for example, processing circuits implemented by memory storing a program, a processor that executes the program, and so forth. The program may be stored in storage 80. It should be noted that although illustrated as separate blocks in the block diagram, all or at least one of drive controller 40, distance calculator 50, or background light measurer 60 may include the same memory and the same processor. Details of processing performed by drive controller 40, distance calculator 50, and background light measurer 60 are described later.

Temperature sensor 70 measures the temperature of light receiver 20 (specifically, image sensor 20A). Temperature sensor 70 outputs the measured temperature of light receiver 20 to drive controller 40. Temperature sensor 70 may directly measure the temperature of light receiver 20, and indirectly measure the temperature of light receiver 20 by measuring the surrounding temperature of light receiver 20, for example. It should be noted that distance measuring device 100 need not include temperature sensor 70.

Storage 80 is a storage device storing information and data necessary for processing performed by distance measuring device 100. For instance, image recognition model 81 used in image recognition and condition table 82 for determining an irradiation condition of light source 10 are stored in storage 80. Storage 80 is implemented as, for example, semiconductor memory or a hard disk drive (HDD). It should be noted that at least a part of storage 80 may be provided in a separate device from distance measuring device 100, and distance measuring device 100 may obtain data stored in storage 80 via a network, such as the Internet.

### [Driving Sequence of Distance Measuring Device]

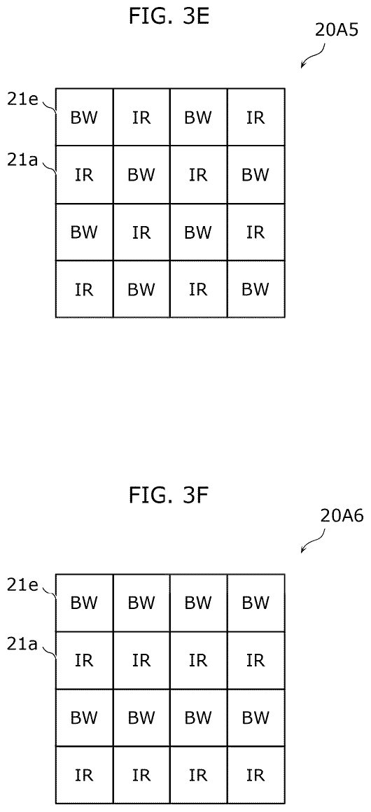

Next, the driving of light source 10 and light receiver 20 when distance measuring device 100 measures the distance, is described. FIG. 4 illustrates an example of a driving sequence of distance measuring device 100 according to the embodiment. FIG. 4 illustrates a driving sequence when light receiver 20 outputs a signal for distance calculator 50 to calculate the distance to a target object, such as recognition target object OBJ.

As illustrated in FIG. 4, in a driving sequence when distance measuring device 100 measures the distance, one frame period includes an emission-exposure period and a readout period. First, during the emission-exposure period, light source 10 emits irradiation light, and IR pixel 21a of light receiver 20 is exposed. Then, during the readout period, a signal based on the charge generated in IR pixel 21a during the emission-exposure period is read out.

During the emission-exposure period, the same sequence of emission and exposure is repeated β times. In the example illustrated in FIG. 4, β times are eight times, and the sequence of emission and exposure for a β1 period is repeated in each period from a β2 period through a β8 period. In the example illustrated in FIG. 4, the β1 period is divided into an A0/A1 period and an A2/A3 period. During the A0/A1 period, an emission control signal including a emission control pulses is output from drive controller 40 to light source 10, and an exposure control signal including α×2 exposure control pulses is output from drive controller 40 to light receiver 20. Moreover, during the A2/A3 period, emission control pulses are not output from drive controller 40 to light source 10, and an exposure control signal including α×2 exposure control pulses is output from drive controller 40 to light receiver 20. As a result, during the emission-exposure period, light source 10 emits pulsed light as irradiation light α×β times.

The emission control pulse is a control pulse instructing light source 10 to emit pulsed light, and causes light source 10 to emit irradiation light when the pulse is at a high level. The exposure control pulse is a control pulse instructing the exposure of IR pixel 21a, and IR pixel 21a is exposed when the pulse is at a low level. During the A0/A1 period, the emission period of light source 10 and the exposure period of IR pixel 21a are associated with a predetermined phase difference.

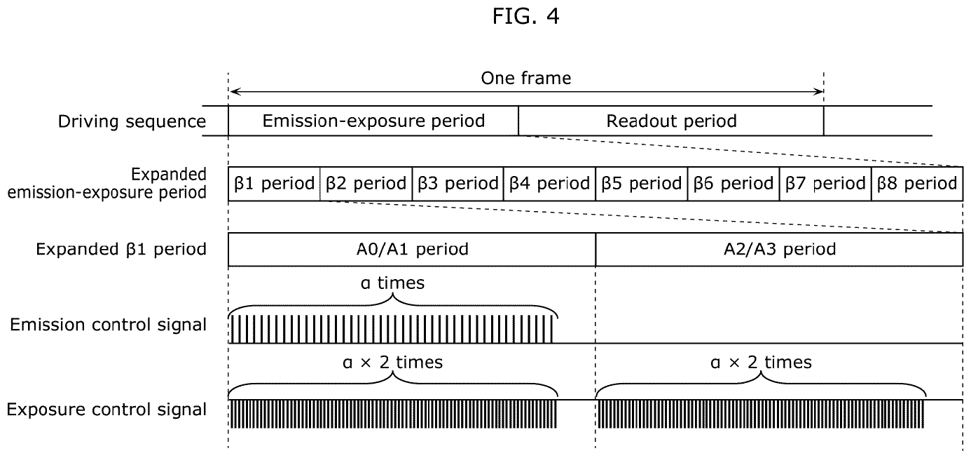

Next, details of the emission control pulse and exposure control pulse are described with reference to FIGS. 5A and 5B. FIG. 5A illustrates an example of timings of an emission control pulse and exposure control pulses during the A0/A1 period. FIG. 5B illustrates an example of timings of an emission control pulse and exposure control pulses during the A2/A3 period. FIGS. 5A and 5B illustrate a repetition unit of the emission control pulse and the exposure control pulses. During the A0/A1 period, the sequence illustrated in FIG. 5A is performed a times, and during the A2/A3 period, the sequence illustrated in FIG. 5B is performed a times.

As illustrated in FIG. 5A, during the A0/A1 period, in response to the output of one emission control pulse, two exposure control pulses A0 and A1 are output. Drive controller 40 outputs an emission control pulse with pulse width Tp. By doing so, light source 10 emits pulsed light with pulse width Tp. Moreover, drive controller 40 outputs exposure control pulses A0 and A1 having mutually different start timings relative to the emission control pulse. In the example illustrated in FIG. 5A, each of the exposure widths (exposure periods) of exposure control pulses A0 and A1 is the same as pulse width Tp of the irradiation light, and the exposure widths do not overlap each other. For instance, exposure control pulse A0 starts at the start timing of the emission control pulse. For instance, exposure control pulse A1 starts at the end timing of the emission control pulse and exposure control pulse A0. That is, the phase difference between exposure control pulse A0 and exposure control pulse A1 is pulse width Tp of the irradiation light. It should be noted that if exposure control pulse A0 and exposure control pulse A1 are output with a phase difference, exposure control pulse A0 need not start at the start timing of the emission control pulse. For instance, exposure control pulse A0 may start with a delay of a predetermined offset from the start timing of the emission control pulse.

As illustrated in FIG. 5B, during the A2/A3 period, emission control pulses are not output, and two exposure control pulses A2 and A3 are output. Drive controller 40 outputs exposure control pulses A2 and A3 having mutually different start timings. In the example illustrated in FIG. 5B, each of the exposure widths (exposure periods) of exposure control pulses A2 and A3 is the same as pulse width Tp of the irradiation light, and the exposure widths do not overlap each other. For instance, exposure control pulse A3 starts at the end timing of emission control pulse A2. It should be noted that during the A2/A3 period, only exposure control pulse A2 may be output without outputting exposure control pulse A3.

For instance, IR pixel 21a includes charge accumulators, and charges generated by exposures corresponding to exposure control pulses A0 to A3, respectively, are distributed to and stored in mutually different charge accumulators. For instance, the number of exposure control pulses A0 to A3 is the same as that of the charge accumulators of IR pixel 21a. During the emission-exposure period, light source 10 emits pulsed light as irradiation light α×β times, and charges generated by α×β exposures are accumulated in each of the charge accumulators. During the readout period, a signal based on the charges accumulated in each of the charge accumulators through the α×β exposures, is read out. That is, IR pixel 21a outputs signals corresponding to the charge amounts generated by exposures for exposure control pulses A0-A3, each of which is performed α×β times.

Drive controller 40 can change the emission count of the pulsed light by changing the number of times the emission control pulse is output. For instance, in changing the emission count of the pulsed light as an irradiation condition of light source 10, drive controller 40 changes α. Drive controller 40 outputs each of exposure control pulses A0 to A3 the same number of times as emission control pulses. Thus, in changing the number of times the emission control pulse is output, drive controller 40 also changes the number of times each of exposure control pulses A0 to A3 is output, by the same amount.

Distance calculator 50 calculates the distance to a target object, such as recognition target object OBJ, irradiated with pulsed light, based on the signal output by each IR pixel 21a according to the driving sequence described above. Distance calculator 50 calculates the distance for each IR pixel 21a to generate a distance image. Distance calculator 50 calculates the distance (for example, the distance from distance measuring device 100 to recognition target object OBJ) in the following manner.

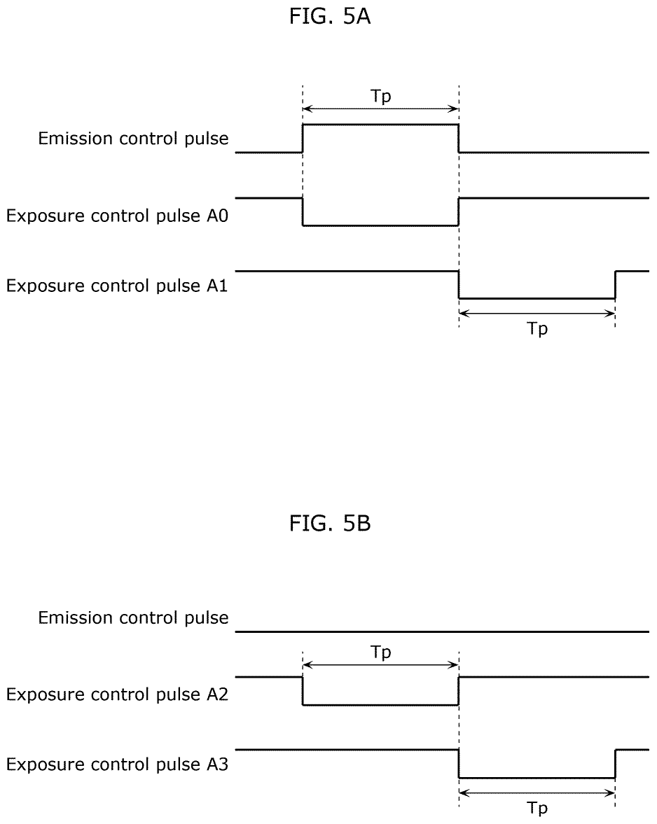

FIG. 6A illustrates examples of signals based on charges generated by exposures during the A0/A1 period. FIG. 6B illustrates examples of signals based on charges generated by exposures during the A2/A3 period. In FIGS. 6A and 6B, the signals based on the charges generated by the exposures according to the respective exposure control pulses are schematically indicated by patterned rectangles. The area of each rectangle corresponds to the magnitude of that signal. It should be noted that FIGS. 6A and 6B illustrate signals S0 to S3 each corresponding to a charge accumulated per exposure. However, in practice, each of IR pixels 21a outputs signals S0 to S3 each based on charges accumulated through α×β exposures, in accordance with the driving sequence described above.

As illustrated in FIG. 6A, the reflected light resulting from reflection of the irradiation light from light source 10 by recognition target object OBJ returns to distance measuring device 100 with a delay of time Δt from the irradiation of the irradiation light, and is incident on light receiver 20. A portion of the reflected light is received by IR pixel 21a in the exposure according to exposure control pulse A0, and is converted into charge. Moreover, since the reflected light returns with a delay of time Δt from the irradiation of the irradiation light, the remaining portion of the reflected light corresponding to delayed time Δt is received by IR pixel 21a in the exposure according to exposure control pulse A1, and is converted into charge. Moreover, background light not including the reflected light is received by IR pixel 21a in the respective exposures according to exposure control pulses A0 and A1, and is converted into charge. As such, signal S0 based on the charge generated by the exposure according to exposure control pulse A0 is a signal including (i) the component of signal S0a corresponding to the reflected light with a time width excluding time Δt from pulse width Tp and (ii) the component of signal S0b corresponding to the background light. Moreover, signal S1 based on the charge generated by the exposure according to exposure control pulse A1 is a signal including (i) the component of signal S1a corresponding to the reflected light with a time width of time Δt and (ii) the component of signal S1b corresponding to the background light.

Moreover, as illustrated in FIG. 6B, during the A2/A3 period, light source 10 does not emit irradiation light. Thus, only the background light not including the reflected light is received by IR pixel 21a by the respective exposures according to exposure control pulses A2 and A3, and is converted into charge. As such, signals S2 and S3 based on the charges generated by the exposures according to exposure control pulses A2 and A3 are signals corresponding to the background light. As such, the magnitudes of signals S0b, S1b, S2, and S3 are practically the same. As such, by deducting signal S2 or S3 from each of signals S0 and S1, it is possible to remove the effects of the background light. Moreover, the sum of signals S0 and S1 after the removal of the effects of the background light becomes a signal based on the reflected light with a time width of pulse width Tp. Accordingly, time Δt is calculated by the following expression.

$$Δ t = Tp \times ( S 1 - S 3 ) / [ ( S 0 - S 2 ) + ( S 1 - S 3 ) ]$$

As a result, provided that the distance from distance measuring device 100 to recognition target object OBJ is defined as D, and the velocity of light is defined as c, the irradiation light from light source 10 makes a round-trip of distance D with time Δt. Thus, distance D is calculated by the following expression. Distance D can also be referred to as the distance traveled by each of the irradiation light and the reflected light.

$$\begin{matrix}D = c \times Δ t / 2 \\ = ( c \times Tp / 2 ) \times ( S 1 - S 3 ) / [ ( S 0 - S 2 ) + ( S 1 - S 3 ) ]\end{matrix}$$

Since distance D is calculated as described above, if the amount of reflected light is small, and the signal levels of signals S0 and S1 based on the reflected light are low, the SN ratio decreases, which leads to lower accuracy of distance measurement. Moreover, if the amount of reflected light increases, and the amount of charge that can be accumulated in the charge accumulator becomes saturated, the signal levels of signals S1 and S2 also reach saturation. By using the method described later, distance measuring device 100 can adjust an irradiation condition of the irradiation light from light source 10, to adjust the amount of reflected light received by light receiver 20. Thus, it is possible to improve the accuracy of distance measurement.

It should be noted that the distance calculated by distance calculator 50 need not be an absolute distance, and may be a relative distance value. For instance, the distance calculated by distance calculator 50 may be a normalized distance with a value from 0 to 1, and time Δt proportional to the distance may be used as a relative distance value. Moreover, as long as the distance can be calculated based on the signal output by light receiver 20, the timings of the emission control pulse and the exposure control pulses are not limited the example described above, and are not particularly limited. For instance, when the effects of background light are minor, distance calculator 50 may calculate the distance without deducting signal S2 or S3 from signals S1 and S0. In this case, the A2/A3 period need not be provided. Moreover, for instance, during the A0/A1 period in which light source 10 emits irradiation light, for one emission control pulse, three or more exposure control pulses having mutually different start timings relative to the emission control pulse may be output. In this case, in an exposure according to at least one of the three or more exposure control pulses, only background light is received by IR pixel 21a. Thus, there is no need to include the A2/A3 period in the driving sequence. Moreover, distance measuring device 100 may perform a driving sequence and calculation of the distance other than those described above, by using various known indirect TOF methods, such as a continuous-wave (CW) TOF method.

Moreover, an IR image may be generated based on the signals obtained in the driving sequence described above. For instance, an IR image can be generated by using the sum of signals S0 and S1 of each IR pixel 21a as a luminance value. An IR image may be generated by distance calculator 50 or image recognizer 30. Also, in generating an IR image, a background light component may be deduced. Moreover, an IR image may be generated by performing an imaging sequence similar to that of an imaging apparatus in which light receiver 20 generates a normal two-dimensional image while light source 10 is emitting irradiation light.

### [Operation]

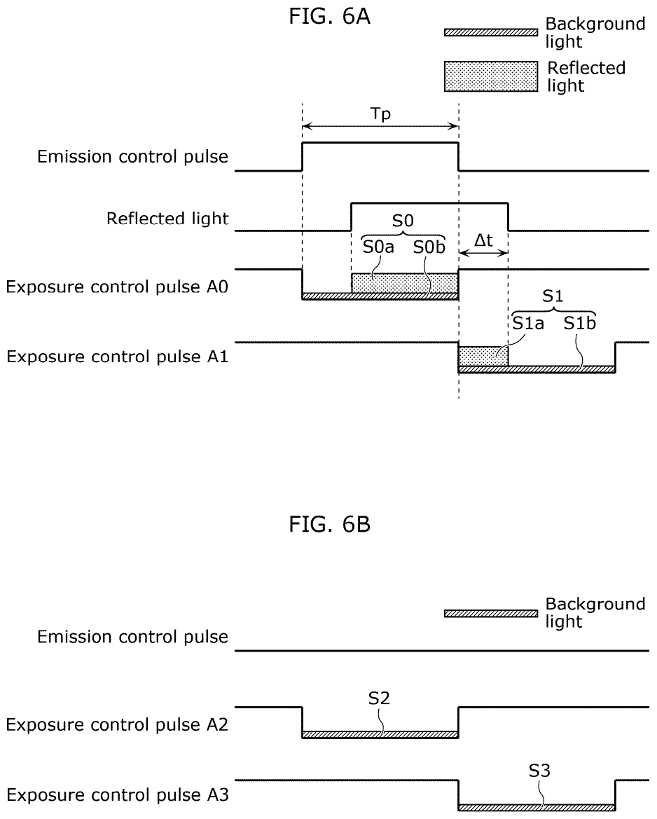

Next, an operation example of distance measuring device 100 according to the embodiment is described. FIG. 7 is a flowchart illustrating an operation example of distance measuring device 100 according to the embodiment. FIG. 7 illustrates an example of a distance measuring method performed by distance measuring device 100. In FIG. 7, the combination of steps S13 and S14 is an example of an image recognition step, step S15 is an example of a driving control step, and step S18 is an example of a distance calculation step. It should be noted that a case where light receiver 20 includes, as an image sensor, image sensor 20A1 including IR pixels 21a illustrated in FIG. 3A is described below. The distance measuring method described below is a method when the distance is measured using IR pixels 21a of image sensor 20A1.

First, drive controller 40 causes light source 10 to irradiate a predetermined range with irradiation light under a first irradiation condition that is a predetermined condition (step S11). Light receiver 20 receives reflected light resulting from reflection within the predetermined range of the irradiation light emitted under the first irradiation condition in step S11, and outputs a signal based on the reflected light (step S12). In steps S11 and S12, for instance, the driving sequence described with reference to FIG. 4 and FIGS. 5A and 5B is performed, and each of IR pixels 21a of light receiver 20 outputs signals S0 to S3 described above. At this time, distance calculator 50 may obtain output signals S0 to S3, and generate a distance image by calculating the distance based on signals S0 to S3. The first irradiation condition for causing light source 10 to emit irradiation light may be a predetermined irradiation condition, or may be the irradiation condition of the irradiation light emitted by light source 10 during the previous operation of distance measuring device 100.

Next, image recognizer 30 obtains an image showing at least a part of the predetermined range irradiated with the irradiation light from light source 10 (step S13). As the image showing at least a part of the predetermined range, for example, image recognizer 30 obtains at least one of an IR image obtained by imaging infrared light, a visible light image (an RGB image or BW image) obtained by imaging visible light, or a distance image. Each of an IR image, a visible light image, and a distance image which are obtained by image recognizer 30 is, for example, an image generated based on the signal output by light receiver 20. Image recognizer 30 may obtain the signal output by light receiver 20 and directly use the obtained signal as an image, and may obtain an image by performing a predetermined calculation on the signal output by light receiver 20 to generate the image. For instance, at a time point before step S13, drive controller 40 controls light source 10 as necessary, as well as light receiver 20, to cause light receiver 20 to output a signal for generating an image to be used in step S13.

In obtaining an IR image or a distance image, image recognizer 30 may generate an image based on the signal output by light receiver 20 as a result of steps S11 and S12 being performed. Moreover, image recognizer 30 may obtain a distance image from distance calculator 50. In this case, distance calculator 50 may generate the distance image based on the signal output by light receiver 20 as a result of steps S11 and S12 being performed.

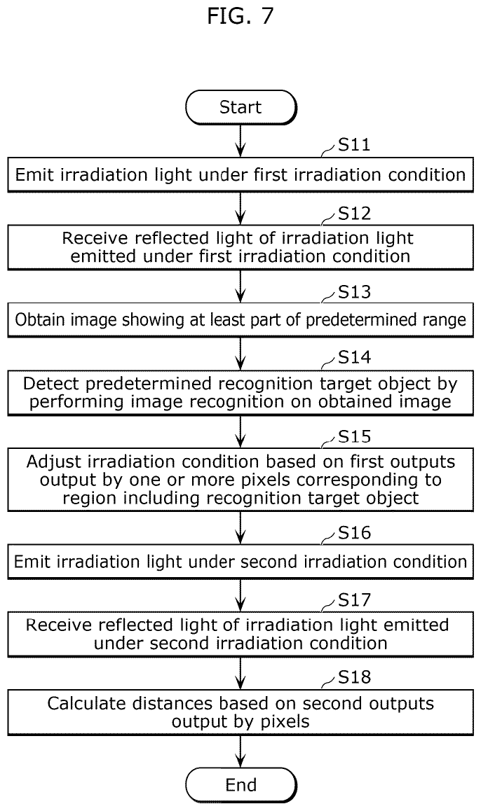

Next, image recognizer 30 detects predetermined recognition target object OBJ by performing image recognition on the obtained image (step S14). FIG. 8 illustrates a specific example of detection of recognition target object OBJ by image recognizer 30. FIG. 8 illustrates an example where a human face is detected as recognition target object OBJ. For instance, image recognizer 30 detects recognition target object OBJ from obtained image 35 by using image recognition model 81 stored in storage 80. Specifically, image recognizer 30 extracts features from image 35, and inputs the extracted features into image recognition model 81. Based on the input features, image recognition model 81 outputs the probability that recognition target object OBJ is present in the image. When the probability output by image recognition model 81 is greater than or equal to a predetermined threshold, image recognizer 30 determines that recognition target object OBJ is present in image 35, and outputs the position of region 36 showing recognition target object OBJ. For instance, region 36 is rectangular, and image recognizer 30 outputs, as the position of region 36, the coordinates defining the rectangular region.

Moreover, when recognition target objects OBJ are detected in image 35, image recognizer 30 may select, from among recognition target objects OBJ, one recognition target object OBJ to be used for adjustment of an irradiation condition, which is described later.

For instance, in selecting one recognition target object OBJ from among recognition target objects OBJ, image recognizer 30 may select recognition target object OBJ object based on registered information. The registered information is, for example, information indicating the face of a person using an application, and is stored in storage 80. Image recognizer 30 preferentially selects recognition target object OBJ corresponding to the registered information.

Moreover, for instance, in selecting one recognition target object OBJ from among recognition target objects OBJ, image recognizer 30 may select recognition target object OBJ based on the distances to recognition target objects OBJ. For instance, image recognizer 30 may select recognition target object OBJ with the shortest distance calculated by distance calculator 50. Moreover, image recognizer 30 may select recognition target object OBJ with a distance closest to a predetermined distance.

Moreover, for instance, in selecting one recognition target object OBJ from among recognition target objects OBJ, image recognizer 30 may select recognition target object OBJ based on the size of each region 36 showing recognition target object OBJ. For instance, image recognizer 30 selects recognition target object OBJ shown in region 36 having the largest number of pixels within the rectangle. Moreover, image recognizer 30 may select recognition target object OBJ shown in region 36 where the number of pixels within the rectangle is closest to a predetermined number of pixels.

Moreover, for instance, in selecting one recognition target object OBJ from among recognition target objects OBJ, image recognizer 30 may select recognition target object OBJ based on the reflectance of each recognition target object OBJ. Even if the distances to recognition target objects OBJ are the same, the signal level of a signal used in distance calculation varies, depending on the reflectance of recognition target object OBJ. Thus, the reflectance of recognition target object OBJ can be calculated from the distance and the signal level. For instance, image recognizer 30 selects recognition target object OBJ with reflectance closest to predetermined reflectance. For instance, when recognition target object OBJ is a human face, image recognizer 30 selects recognition target object OBJ with reflectance closest to 50% which is approximate reflectance of a human face.

It should be noted that steps S11 and S12 may be performed after step S13 or step S14, as long as steps S11 and S12 are performed before step S15, which is described below.

Next, when image recognizer 30 has detected recognition target object OBJ, drive controller 40 adjusts an irradiation condition of the irradiation light emitted by light source 10, based on a first output that is output by each of one or more IR pixels 21a corresponding to region 36 including recognition target object OBJ among IR pixels 21a (step S15). Thus, drive controller 40 determines a second irradiation condition that is the adjusted irradiation condition. The first output is output by each of one or more IR pixels 21a described above, based on the reflected light within a predetermined range of the irradiation light emitted under the first irradiation condition. The first output is an output including one or more signals output by IR pixel 21a, and includes, for example, signal S0 and signal S1 that are signals based on the reflected light explained with reference to FIG. 6A. The first output may further include signal S2 and signal S3. Based on the first output, drive controller 40 adjusts an irradiation condition of the irradiation light to bring the amount of reflected light received by IR pixel 21a to a desired amount of light. For instance, drive controller 40 adjusts the amount of irradiation light reaching recognition target object OBJ by adjusting the irradiation condition of the irradiation light, to bring the amount of reflected light received by IR pixel 21a closer to the desired amount of light. Moreover, drive controller 40 adjusts an exposure condition of IR pixel 21a as necessary, as well as the irradiation condition of the irradiation light.

One or more IR pixels 21a described above are, for example, IR pixels 21a that receive light from region 36 including recognition target object OBJ. Moreover, one or more IR pixels 21a described above may be IR pixels 21a that receive light from a central region or the closest region of recognition target object OBJ among regions into which region 36 including recognition target object OBJ is divided. By doing so, even if region 36 includes, for example, a background, it can be excluded from the region to be used for adjusting an irradiation condition. The central region is a central region among the regions into which region 36 is divided. Moreover, the closest region is a region, among the regions into which region 36 is divided, that includes the point at which the distance from distance measuring device 100 to recognition target object OBJ is the shortest. The closest region is determined using the distances calculated by distance calculator 50.

For instance, drive controller 40 adjusts an irradiation condition of the irradiation light by adjusting at least one of the emission count of pulsed light emitted as irradiation light by light source 10, the emission intensity of light source 10, or the distribution angle of the irradiation light. In other words, irradiation condition adjustment methods by drive controller 40 (adjustment targets of irradiation conditions for drive controller 40) include at last one of the emission count of pulsed light emitted as the irradiation light by light source 10, the emission intensity of light source 10, or the distribution angle of the irradiation light. Drive controller 40 may adjust at least two of the emission count of pulsed light emitted as the irradiation light by light source 10, the emission intensity of light source 10, or the distribution angle of the irradiation light.

Here, in step S15, a method (algorithm) for adjusting an irradiation condition of irradiation light by drive controller 40 is described. The following first method and second method are exemplified as methods for adjusting an irradiation condition of irradiation light by drive controller 40.

In the first method, drive controller 40 calculates the representative value of the signal levels of the first outputs output by one or more IR pixels 21a described above, and adjusts an irradiation condition of irradiation light based on the calculated representative value. The representative value is, for example, the mean or the median. For instance, the signal level of the first output is obtained by summing signal S0 and signal S1. The signal level of the first output can also be referred to as the luminance value of reflected light for IR pixel 21a.

In calculating the representative value of the signal levels of the first outputs, drive controller 40 may calculate the representative value by calculating the mean or median of one or more signal levels greater than or equal to a predetermined threshold among the signal levels of the first outputs output by one or more IR pixels 21a described above. By doing so, a first output from IR pixel 21a which receives reflected light from a region that becomes a background is excluded from calculation of the representative value, since the amount of reflected light received by that IR pixel 21a is low and the signal level becomes low. Moreover, when recognition target object OBJ is a human face, a first output from IR pixel 21a which receives reflected light from hair with low reflectance is excluded from calculation of the representative value, since the amount of reflected light received by that IR pixel 21a is low and the signal level becomes low.

For instance, drive controller 40 adjusts an irradiation condition to bring the calculated representative value to a target signal level. For instance, drive controller 40 calculates the ratio between the calculated representative value and the target signal level (ratio=target signal level/calculated representative value), and adjusts an irradiation condition of the irradiation light to change the amount of light reaching recognition target object OBJ by the above ratio relative to the first irradiation condition. For instance, drive controller 40 sets the adjusted irradiation condition by multiplying, by the above ratio, the emission count of the pulsed light or the emission intensity of light source 10 under the first irradiation condition.

In the second method, drive controller 40 calculates the representative value of distances to the region including recognition target object OBJ that are calculated based on the first outputs output by one or more IR pixels 21a described above, and adjusts an irradiation condition of the irradiation light based on the calculated representative value. The representative value is, for example, the mean or the median. For instance, by using the method described above, distance calculator 50 calculates the distances using signals S0 to S3 included in the first outputs.

In calculating the distance representative value, drive controller 40 may calculate the representative value by calculating the mean or median of one or more distances less than or equal to a predetermined threshold among the distances to the region including recognition target object OBJ that are calculated based on the first outputs output by one or more IR pixels 21a described above. By doing so, a first output from IR pixel 21a that receives reflected light from a region that becomes a background is excluded from calculation of the representative value.

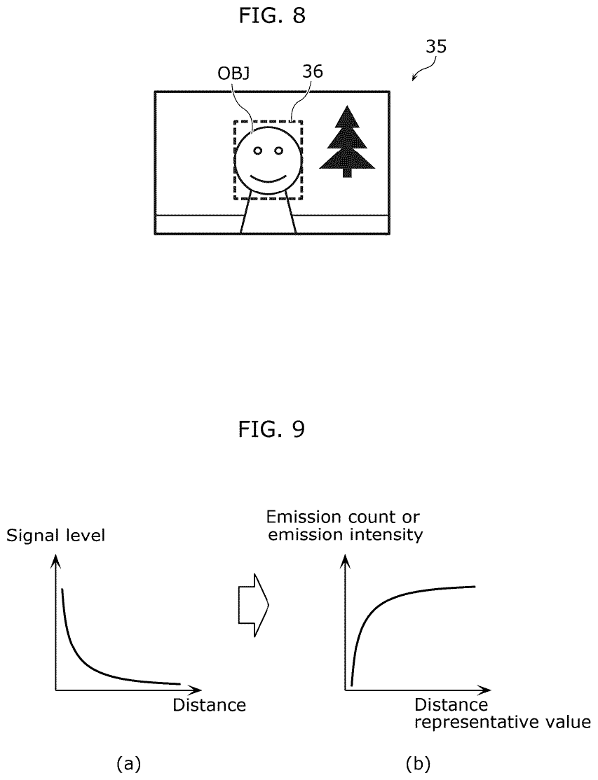

For instance, drive controller 40 adjusts an irradiation condition of the irradiation light, using the calculated distance representative value and condition table 82 stored in storage 80. Condition table 82 is an example of a table associating the distance representative value with the set value of an irradiation condition. Drive controller 40 adjusts an irradiation condition of the irradiation light by referencing condition table 82. FIG. 9 is a figure for explaining condition table 82 for adjusting an irradiation condition of irradiation light. (a) in FIG. 9 illustrates a relationship between the distance to recognition target object OBJ and the signal level of a signal output by IR pixel 21a when recognition target object OBJ is irradiated with irradiation light under a certain irradiation condition and the distance to recognition target object OBJ is calculated. Moreover, (b) in FIG. 9 illustrates a relationship between the distance representative value and the set value of an irradiation condition (for example, the emission count of pulsed light or the emission intensity of light source 10) in condition table 82.

As the distance from distance measuring device 100 to recognition target object OBJ increases, the amount of light reaching recognition target object OBJ decreases due to attenuation of the irradiation light. As such, for predetermined recognition target object OBJ, since the reflectance of recognition target object OBJ is also determined, the amount of reflected light received by IR pixel 21a is also determined by the distance to recognition target object OBJ. For instance, when recognition target object OBJ is a human face, the reflectance is around 50%. As a result, as illustrated in (a) in FIG. 9, as the distance to recognition target object OBJ increases, the signal level of a signal output by IR pixel 21a decreases based on the reflected light. Accordingly, as the distance to recognition target object OBJ increases, the SN ratio decreases, which, in turn, decreases the accuracy of distance measurement. Because of this, as illustrated in (b) in FIG. 9, to bring the signal level of a signal output by IR pixel 21a to a target signal level, based on the relationship illustrated in (a) in FIG. 9, condition table 82 is set in which the emission count or the emission intensity increases with an increase in the representative value of distances calculated as above. This makes it possible to appropriately adjust an irradiation condition, which can improve the accuracy of distance measurement. If the reflectance of a target object irradiated with irradiation light differs from that of recognition target object OBJ, the relationship between the distance and the signal level changes from the relationship indicated in (a) in FIG. 9. However, as described above, an irradiation condition is adjusted when image recognizer 30 has detected recognition target object OBJ. Thus, it is possible to avoid a situation in which the irradiation condition is not appropriately adjusted since the reflectance of a target object irradiated with irradiation light differs from expected reflectance. It should be noted that in the second method, the first irradiation condition described above is set to, for example, the irradiation condition used for setting condition table 82. For instance, when condition table 82 with the relationship illustrated in (b) in FIG. 9 is used, the first irradiation condition in which the relationship illustrated in (a) in FIG. 9 is obtained is set. Also in the first method, a table associating the representative value of signal levels with the set value of an irradiation condition may be used.

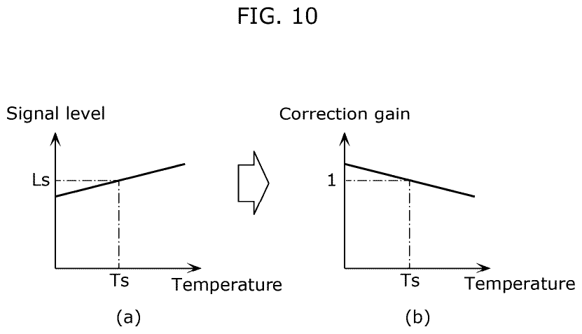

Moreover, in the second method, based on the temperature of light receiver 20 measured by temperature sensor 70, drive controller 40 may correct the second irradiation condition determined by adjusting an irradiation condition of the irradiation light based on the distance representative value. Specifically, drive controller 40 corrects the second irradiation condition such that the amount of light irradiated onto recognition target object OBJ decreases with an increase in the temperature of light receiver 20 measured by temperature sensor 70. FIG. 10 is a figure for explaining a method for correcting the second irradiation condition based on the temperature of light receiver 20. (a) in FIG. 10 illustrates a relationship between the temperature of light receiver 20 and the signal level of a signal output by IR pixel 21a when light receiver 20 receives a certain amount of light. Moreover, (b) in FIG. 10 illustrates a relationship between a correction gain for correcting the second irradiation condition and the temperature of light receiver 20.

The sensitivity of IR pixel 21a increases with an increase in the temperature. Thus, as illustrated in (a) in FIG. 10, when the amount of received light is the same, the signal level of a signal output by IR pixel 21a increases with an increase in the temperature of light receiver 20. As such, for instance, drive controller 40 multiplies the emission count of pulsed light or the emission intensity of light source 10 adjusted based on condition table 82 described above, by the correction gain, as illustrated in (b) in FIG. 10, that decreases with an increase in the temperature of light receiver 20. Here, condition table 82 is used which is set based on the relationship between the distance to recognition target object OBJ and the signal level of a signal output by IR pixel 21a at reference temperature Ts. The correction gain is 1 at reference temperature Ts. Provided that the signal level at reference temperature Ts is reference level Ls in the relationship illustrated in (a) in FIG. 10, as the correction gain at a temperature other than reference temperature Ts, for example, a value obtained by dividing reference level Ls by the signal level at that temperature is used. By drive controller 40 correcting the second irradiation condition based on the temperature of light receiver 20 in this manner, even if the temperature of light receiver 20 differs from reference temperature Ts when condition table 82 was set, it is possible to bring the signal level of a signal output by IR pixel 21a closer to the target signal level.

It should be noted that when image recognizer 30 has not detected recognition target object OBJ, drive controller 40 may adjust an irradiation condition of irradiation light based on the output by IR pixel 21a that is based on reflected light from a target object other than recognition target object OBJ, or may not adjust an irradiation condition of irradiation light. Moreover, when image recognizer 30 has not detected recognition target object OBJ, drive controller 40 may stop the driving of light source 10 and light receiver 20.

Moreover, drive controller 40 may change the adjustment method of an irradiation condition of irradiation light according to the signal level of a third output that each of IR pixels 21a outputs based on the reception amount of background light not including the reflected light. The irradiation condition adjustment method in this case includes, for example, (i) the emission count of pulsed light emitted as irradiation light by light source 10 and (ii) at least one of the emission intensity of light source 10 or the distribution angle of irradiation light. The third output is an output including one or more signals output by IR pixel 21a, and is obtained by background light measurer 60. For instance, background light measurer 60 obtains, as the third output, at least one of signal S2 or signal S3 output by IR pixel 21a as a result of steps S11 and S12 being performed. The signal level of the third output can also be referred to as the luminance value of background light for IR pixel 21a. It should be noted that background light measurer 60 may obtain the third output that is output by IR pixel 21a as a result of light receiver 20 receiving background light in a step other than step S12.

For instance, drive controller 40 calculates the representative value of the signal levels of third outputs output by IR pixels 21a. The representative value is, for example, the mean or the median. For instance, when the calculated representative value of the signals of the third outputs is greater than or equal to a predetermined threshold, that is, when there is a large amount of background light, among the irradiation condition adjustment methods, drive controller 40 uses an adjustment method in which the illuminance of light irradiated onto recognition target object OBJ is higher than that in the other adjustment methods.

For instance, when the calculated representative value of the signal levels of the third outputs is greater than or equal to the predetermined threshold and an irradiation condition is adjusted such that the amount of irradiation light reaching recognition target object OBJ is increased compared to the first irradiation condition, drive controller 40 adjusts, as an irradiation condition of the irradiation light, at least one of the emission intensity of light source 10 or the distribution angle of the irradiation light. Based on the signal levels of the first outputs or the distances calculated based on the first outputs, drive controller 40 may determine whether or not to adjust an irradiation condition such that the amount of irradiation light reaching recognition target object OBJ is increased compared to the first irradiation condition. As described with reference to FIG. 6A, signal S0 and signal S1 based on the reflected light from recognition target object OBJ include signal S0b and signal S1b, respectively, that are components corresponding to background light. As such, when the background light components increase in signals S0 and S1, signal S0a and signal S1a decrease which are components of signals S0 and S1 corresponding to the reflected light used for calculating the distance. Accordingly, the SN ratio decreases, which, in turn, decreases the accuracy of distance measurement. As such, under the condition with a large amount of background light components, when the emission count of pulsed light is increased as an irradiation condition of irradiation light, the exposure count also increases. As a result, the background light components also increase, which makes it difficult to effectively enhance the accuracy of distance measurement. By contrast, when the emission intensity of light source 10 or the distribution angle of irradiation light is adjusted to increase the amount of light reaching recognition target object OBJ, the illuminance of light irradiated onto recognition target object OBJ is increased compared to when the emission count of pulsed light is increased, that is, there will be more beams of irradiation light incident on the surface of recognition target object OBJ. As such, when the emission intensity of light source 10 or the distribution angle of irradiation light is adjusted as an irradiation condition of irradiation light, it is possible to increase the amount of reflected light relative to the amount of background light per exposure. As a result, the background light components in signals S0 and S1 decrease, which can improve the SN ratio. Accordingly, it is possible to effectively improve the accuracy of distance measurement.

Meanwhile, when the calculated representative value of the signal levels of the third outputs is greater than or equal to the predetermined threshold and an irradiation condition is adjusted such that the amount of irradiation light reaching recognition target object OBJ is decreased compared to the first irradiation condition, drive controller 40 adjusts the emission count of pulsed light as an irradiation condition of the irradiation light. By doing so, the amount of reflected light relative to the amount of background light per exposure will not decrease, which can suppress a further decrease in the SN ratio.

Moreover, when the calculated representative value of the signal levels of the third outputs is less than the predetermined threshold, drive controller 40 may adjust an irradiation condition by a predetermined adjustment method regardless of how the irradiation condition is adjusted, or may adjust an irradiation condition using the same adjustment method as when the representative value is greater than or equal to the predetermined threshold.

The explanation returns to FIG. 7. Next, drive controller 40 causes light source 10 to irradiate the predetermined range with irradiation light under the second irradiation condition, which is the adjusted irradiation condition in step S15 (step S16). Light receiver 20 receives reflected light resulting from reflection within the predetermined range of the irradiation light emitted under the second irradiation condition in step S16, and outputs a signal based on the reflected light (step S17). In steps S16 and S17, for instance, the driving sequence described with reference to FIG. 4 and FIGS. 5A and 5B is performed. IR pixel 21a of light receiver 20 outputs signals S0 to S3 described above.

Then, distance calculator 50 calculates the distances to recognition target object OBJ based on second outputs output by IR pixels 21a (step S18). The second output is output by each of IR pixels 21a based on the reflected light within the predetermined range of the irradiation light emitted under the second irradiation condition. The second output includes one or more signals output by IR pixel 21a, and includes, for example, signals S0 to S3 described above. Distance calculator 50 obtains the second output including signals S0 to S3 from each of IR pixels 21a, and generates a distance image by calculating the distance based on signals S0 to S3 for each of IR pixels 21a. The distance image is an image including the distances calculated based on reflected light received by IR pixels 21a, as the pixel values of IR pixels 21a. In the embodiment, an irradiation condition of irradiation light emitted by light source 10 is adjusted based on the first outputs output by one or more IR pixels 21a corresponding to recognition target object OBJ detected by image recognizer 30. This makes it possible to appropriately adjust the amount of irradiation light reaching recognition target object OBJ, which, in turn, can enhance the measurement accuracy of the distance to recognition target object OBJ.

For instance, distance calculator 50 outputs a generated distance image to an external destination. The distance image output by distance calculator 50 is input into, for example, an external information processing device, and is used in applications in, for example, a facial authentication system and a driver monitoring system.

### (Others)

Although the distance measuring device according to one or more aspects of the present disclosure is described above based on the embodiment, the present disclosure is not limited to the embodiment. The one or more aspects of the present disclosure may encompass embodiments obtained by making various modifications envisioned by those skilled in the art to each embodiment and embodiments created by combining elements from different embodiments, provided that these embodiments are within the scope of the present disclosure.

Moreover, the distance measuring device according to the present disclosure need not include all elements described in the above embodiment, and may include only elements for performing an intended operation.

Moreover, in the above embodiment, as a non-limiting example, the distance measuring device is a distance measuring device that measures the distance by an indirect TOF method. The distance measuring device according to the present disclosure may be a distance measuring device that measures the distance by a direct TOF method. Even in a distance measuring device that measures the distance by a direct TOF method, the drive controller can adjust an irradiation condition to suit a recognition target object, by adjusting the irradiation condition for emission of irradiation light in the same manner as in the above embodiment.

Moreover, in the above embodiment, each element may be implemented by executing a software program suitable for the element. Each element may be implemented by a program executer, such as a CPU or a processor, reading out and executing a software program stored in a recording medium, such as a hardware disk or semiconductor memory.

Moreover, each element may be implemented as hardware. Each element may be a circuit (or an integrated circuit). These circuits, as a whole, may form a signal circuit, or they may be separate circuits. Moreover, these circuits may be general-purpose circuits or dedicated circuits.

Moreover, a general or specific aspect of the present disclosure may be implemented as a system, a device, a method, an integrated circuit, a computer program, or a computer-readable recording medium, such as a CD-ROM. Moreover, a general or specific aspect of the present disclosure may be implemented as any combination of the system, device, method, integrated circuit, computer program, and recording medium.

For instance, the present disclosure may be implemented as the distance measuring device in the above embodiment, a control device that controls the distance measuring device, a distance measuring method including steps (processes) performed by the elements of the distance measuring device, a program for causing a computer to execute the distance measuring method, and a non-transitory computer-readable recording medium having recorded thereon the program.

Examples of the distance measuring device and the distance measuring method according to the present disclosure described based on the above embodiment are described below. The distance measuring device and the distance measuring method according to the present disclosure are not limited to the examples below.

For instance, a distance measuring device according to a first aspect of the present disclosure includes: a light source that irradiates a predetermined range with irradiation light; a light receiver including a plurality of pixels that receive reflected light resulting from reflection of the irradiation light within the predetermined range; an image recognizer that obtains an image showing at least a part of the predetermined range, and detects a recognition target object that is predetermined, by performing image recognition on the image obtained; a drive controller that, when the image recognizer has detected the recognition target object, (i) adjusts an irradiation condition of the irradiation light emitted by the light source, based on a first output that each of one or more pixels outputs based on the reflected light of the irradiation light emitted under a predetermined irradiation condition, the one or more pixels being pixels corresponding to a region including the recognition target object among the plurality of pixels, and (ii) causes the light source to emit the irradiation light under the irradiation condition adjusted; and a distance calculator that calculates a distance to the recognition target object, based on a second output that each of the plurality of pixels outputs based on the reflected light of the irradiation light emitted under the irradiation condition adjusted.

Thus, the drive controller can adjust the irradiation condition for emitting the irradiation light for measuring the distance, based on the first outputs output by the one or more pixels corresponding to the region including the predetermined recognition target object. This makes it possible to adjust the irradiation condition to suit the recognition target object, which can improve the accuracy of distance measurement.

Moreover, for instance, a distance measuring device according to a second aspect of the present disclosure is the distance measuring device according to the first aspect in which the drive controller calculates a representative value of signal levels of the first outputs output by the one or more pixels, and adjusts the irradiation condition of the irradiation light based on the representative value calculated.

The signal levels of the first outputs correspond to the amount of reflected light received by the one or more pixels. Thus, by using the representative value of the signal levels of the first outputs, it possible to adjust the irradiation condition with high accuracy.

Moreover, for instance, a distance measuring device according to a third aspect of the present disclosure is the distance measuring device according to the second aspect in which the drive controller adjusts the irradiation condition of the irradiation light to bring the representative value to a target signal level.

Thus, it is possible to adjust the irradiation condition to bring the amount of reflected light received by the one or more pixels to a desired amount.

Moreover, for instance, a distance measuring device according to a fourth aspect of the present disclosure is the distance measuring device according to the second or third aspect in which the drive controller calculates the representative value from one or more signal levels greater than or equal to a predetermined threshold among the signal levels of the first outputs output by the one or more pixels.

Thus, even if a background or the like is included in the region including the detected recognition target object, the representative value can be calculated excluding a background portion with a low signal level.

Moreover, for instance, a distance measuring device according to a fifth aspect of the present disclosure is the distance measuring device according to the first aspect in which the drive controller calculates a representative value of distances to the region including the recognition target object that are calculated based on the first outputs output by the one or more pixels, and adjusts the irradiation condition of the irradiation light based on the representative value calculated.

Since the amount of irradiation light reaching the recognition target object varies depending on the distance to the recognition target object, it is possible to adjust the irradiation condition with high accuracy by using the distance representative value.

Moreover, for instance, a distance measuring device according to a sixth aspect of the present disclosure is the distance measuring device according to the fifth aspect in which the drive controller adjusts the irradiation condition of the irradiation light by referencing a table associating the representative value with a set value of the irradiation condition of the irradiation light.

Thus, it is possible to adjust the irradiation condition by just referencing the table, which can simply the processing. Moreover, the distance is calculated from the first outputs output by the one or more pixels corresponding to the region including the recognition target object. Thus, the reflectance of a target object for distance calculation is predetermined, and a table of the set value of an appropriate irradiation condition can be used.

Moreover, for instance, a distance measuring device according to a seventh aspect of the present disclosure is the distance measuring device according to the fifth or sixth aspect in which the drive controller calculates the representative value from one or more distances less than or equal to a predetermined threshold among the distances to the region including the recognition target object that are calculated based on the first outputs output by the one or more pixels.

Thus, even if a background or the like is included in the region including the detected recognition target object, the representative value can be calculated excluding a background portion.

Moreover, for instance, a distance measuring device according to an eighth aspect of the present disclosure is the distance measuring device according to any one of the fifth to seventh aspects that further includes a temperature sensor that measures temperature of the light receiver, in which based on the temperature of the light receiver measured by the temperature sensor, the drive controller corrects the irradiation condition adjusted.

Thus, even when the sensitivity of the light receiver varies depending on the temperature, it is possible to suppress the effects of the sensitivity by correcting the adjusted irradiation condition.

Moreover, for instance, a distance measuring device according to a ninth aspect of the present disclosure is the distance measuring device according to any one of the first to eighth aspects in which the one or more pixels corresponding to the region including the recognition target object are pixels that receive light from a central region or a closest region of the recognition target object among regions into which the region including the recognition target object is divided.

Thus, it is possible to use first outputs from pixels more suitable for the adjustment of the irradiation condition out of the regions of recognition target object.

Moreover, for instance, a distance measuring device according to a tenth aspect of the present disclosure is the distance measuring device according to any one of the first to ninth aspects that further includes a background light measurer that obtains a third output that each of the plurality of pixels outputs based on a reception amount of background light not including the reflected light, in which the drive controller changes an adjustment method of the irradiation condition of the irradiation light according to signal levels of the third outputs.

Thus, it is possible to use an irradiation condition adjustment method in which the effects of the background light are mitigated according to the amount of background light. For instance, if there is a large amount of background light, among the irradiation condition adjustment methods, an adjustment method in which the illuminance of light irradiated onto the recognition target object is higher than that in the other adjustment methods is used.

Moreover, for instance, a distance measuring device according to an eleventh aspect of the present disclosure is the distance measuring device according to any one of the first to tenth aspects in which the light source emits pulsed light as the irradiation light more than one time, and the drive controller adjusts the irradiation condition of the irradiation light by adjusting at least a total number of times the pulsed light is emitted.

Thus, it is possible to adjust the irradiation condition by adjusting the emission count of the pulsed light of the light source, which makes it easier to adjust the irradiation condition.

Moreover, for instance, a distance measuring device according to a twelfth aspect of the present disclosure is the distance measuring device according to any one of the first to eleventh aspects in which the light source is configured to change emission intensity of the light source, and the drive controller adjusts the irradiation condition of the irradiation light by adjusting at least the emission intensity.

This makes it possible to adjust the irradiation condition without changing the irradiation time of the irradiation light.

Moreover, for instance, a distance measuring device according to a thirteenth aspect of the present disclosure is the distance measuring device according to any one of the first to twelfth aspects in which the light source is configured to change a distribution angle of the irradiation light, and the drive controller adjusts the irradiation condition of the irradiation light by adjusting at least the distribution angle.

Thus, it is possible to adjust the amount of irradiation light reaching the recognition target object even if the emission amount of the irradiation light of the light source is the same. For instance, even if the amount of irradiation light reaching the recognition target object is increased, it is not necessary to increase the emission amount of the light source, which can save energy.

Moreover, for instance, a distance measuring method according to a fourteenth aspect of the present disclosure is a distance measurement method performed by a distance measuring device, the distance measuring device including: a light source that irradiates a predetermined range with irradiation light; and a light receiver including a plurality of pixels that receive reflected light resulting from reflection of the irradiation light within the predetermined range. The distance measuring method includes: obtaining an image showing at least a part of the predetermined range, and detecting a recognition target object that is predetermined, by performing image recognition on the image obtained; when the recognition target object is detected in the obtaining and detecting of the image and the recognition target object, (i) adjusting an irradiation condition of the irradiation light emitted by the light source, based on a first output that each of one or more pixels outputs based on the reflected light of the irradiation light emitted under a predetermined irradiation condition, the one or more pixels being pixels corresponding to a region including the recognition target object among the plurality of pixels, and (ii) causing the light source to emit the irradiation light under the irradiation condition adjusted; and calculating a distance to the recognition target object based on a second output that each of the plurality of pixels outputs based on the reflected light of the irradiation light emitted under the irradiation condition adjusted.

According to the above distance measuring method, it possible to adjust the irradiation condition to suit the recognition target object, which can improve the accuracy of distance measurement, in the same manner as the distance measuring device according to the first aspect.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

A distance measuring device and so forth according to the present disclosure are usable for various applications, such as a sensing system and an authentication system that use a distance image, as well as a distance measuring system.

1. A distance measuring device comprising:
a light source that irradiates a predetermined range with irradiation light;
a light receiver including a plurality of pixels that receive reflected light resulting from reflection of the irradiation light within the predetermined range;
an image recognizer that obtains an image showing at least a part of the predetermined range, and detects a recognition target object that is predetermined, by performing image recognition on the image obtained;
a drive controller that, when the image recognizer has detected the recognition target object, (i) adjusts an irradiation condition of the irradiation light emitted by the light source, based on a first output that each of one or more pixels outputs based on the reflected light of the irradiation light emitted under a predetermined irradiation condition, the one or more pixels being pixels corresponding to a region including the recognition target object among the plurality of pixels, and (ii) causes the light source to emit the irradiation light under the irradiation condition adjusted; and
a distance calculator that calculates a distance to the recognition target object, based on a second output that each of the plurality of pixels outputs based on the reflected light of the irradiation light emitted under the irradiation condition adjusted.

2. The distance measuring device according to claim 1, wherein
the drive controller calculates a representative value of signal levels of the first outputs output by the one or more pixels, and adjusts the irradiation condition of the irradiation light based on the representative value calculated.

3. The distance measuring device according to claim 2, wherein
the drive controller adjusts the irradiation condition of the irradiation light to bring the representative value to a target signal level.

4. The distance measuring device according to claim 2, wherein
the drive controller calculates the representative value from one or more signal levels greater than or equal to a predetermined threshold among the signal levels of the first outputs output by the one or more pixels.

5. The distance measuring device according to claim 1, wherein
the drive controller calculates a representative value of distances to the region including the recognition target object that are calculated based on the first outputs output by the one or more pixels, and adjusts the irradiation condition of the irradiation light based on the representative value calculated.

6. The distance measuring device according to claim 5, wherein
the drive controller adjusts the irradiation condition of the irradiation light by referencing a table associating the representative value with a set value of the irradiation condition of the irradiation light.

7. The distance measuring device according to claim 5, wherein
the drive controller calculates the representative value from one or more distances less than or equal to a predetermined threshold among the distances to the region including the recognition target object that are calculated based on the first outputs output by the one or more pixels.

8. The distance measuring device according to claim 5, further comprising:
a temperature sensor that measures temperature of the light receiver, wherein
based on the temperature of the light receiver measured by the temperature sensor, the drive controller corrects the irradiation condition adjusted.

9. The distance measuring device according to claim 1, wherein
the one or more pixels corresponding to the region including the recognition target object are pixels that receive light from a central region or a closest region of the recognition target object among regions into which the region including the recognition target object is divided.

10. The distance measuring device according to claim 1, further comprising:
a background light measurer that obtains a third output that each of the plurality of pixels outputs based on a reception amount of background light not including the reflected light, wherein
the drive controller changes an adjustment method of the irradiation condition of the irradiation light according to signal levels of the third outputs.

11. The distance measuring device according to claim 1, wherein
the light source emits pulsed light as the irradiation light more than one time, and
the drive controller adjusts the irradiation condition of the irradiation light by adjusting at least a total number of times the pulsed light is emitted.

12. The distance measuring device according to claim 1, wherein
the light source is configured to change emission intensity of the light source, and
the drive controller adjusts the irradiation condition of the irradiation light by adjusting at least the emission intensity.

13. The distance measuring device according to claim 1, wherein
the light source is configured to change a distribution angle of the irradiation light, and
the drive controller adjusts the irradiation condition of the irradiation light by adjusting at least the distribution angle.

14. A distance measuring method performed by a distance measuring device,
the distance measuring device including:
a light source that irradiates a predetermined range with irradiation light; and
a light receiver including a plurality of pixels that receive reflected light resulting from reflection of the irradiation light within the predetermined range,
the distance measuring method comprising:
obtaining an image showing at least a part of the predetermined range, and detecting a recognition target object that is predetermined, by performing image recognition on the image obtained;
when the recognition target object is detected in the obtaining and detecting of the image and the recognition target object, (i) adjusting an irradiation condition of the irradiation light emitted by the light source, based on a first output that each of one or more pixels outputs based on the reflected light of the irradiation light emitted under a predetermined irradiation condition, the one or more pixels being pixels corresponding to a region including the recognition target object among the plurality of pixels, and (ii) causing the light source to emit the irradiation light under the irradiation condition adjusted; and
calculating a distance to the recognition target object based on a second output that each of the plurality of pixels outputs based on the reflected light of the irradiation light emitted under the irradiation condition adjusted.
